(19) United States
(12) Patent Application Publication
(10) Pub. No.: US 2014/0222265 A1
(43) Pub. Date: Aug. 7, 2014

(54) AC/DC HYBRID ELECTRIC DRIVETRAIN SYSTEM AND METHOD FOR USE IN HIGH-PERFORMANCE ELECTRIC VEHICLES

(71) Applicant: Valery Miftakhov, San Mateo, CA (US)

(72) Inventor: Valery Miftakhov, San Mateo, CA (US)

(21) Appl. No.: 13/761,190

(22) Filed: Feb. 7, 2013

(51) Int. Cl. B60L 15/20

(52) U.S. Cl. CPC B60L 15/20
USPC 701/22

(57) ABSTRACT

Described is a three-part electric vehicle drivetrain architecture incorporating (1) a hybrid motor assembly incorporating both AC and DC motor architectures to combine high power of the DC motor with the efficiency of the AC motor, (2) a power stage that delivers the precise amount of the electrical energy to the motors, and (3) a microprocessor-based control system that performs all the control functions of the drivetrain. In the hybrid AC/DC motor assembly, the DC motor and one AC motor are arranged back to back with their driveshafts mechanically coupled. In this arrangement, the motors are integrated into one unit by removing back/front plates and replacing individual shafts with a single shaft. Mechanical connection of such a motor assembly to the wheels is performed via the conventional transmission/driveshaft.

### CROSS-REFERENCE TO RELATED APPLICATION

This regular U.S. patent application relies on and claims the benefit of priority to U.S. provisional patent application No. 61/596,119 filed on Feb. 7, 2012, the entire disclosure of which is incorporated by reference herein.

### BACKGROUND OF THE INVENTION

1. Field of the Invention

The present invention relates generally to the field of sustainable (alternative energy) transportation, and more specifically to design and manufacture of electric vehicles, as well as electronic systems and solutions used in electric vehicles.

2. Description of the Related Art

Alternative energy transportation is the segment of the automotive industry focused on application of non-gasoline fuels in transportation. Examples of the fuels falling under this definition include, without limitation: compressed natural gas, ethanol, biofuels, hydrogen, electricity and the like. The description below deals with the sub-segment of sustainable transportation that uses electric power to propel the vehicle (traction power). Electric vehicles are generally divided into 3 broad categories: (1) hybrid vehicles, (2) plug-in hybrid vehicles, and (3) battery electric vehicles. Hybrid vehicles incorporate both the electric propulsion and internal combustion engine (ICE) systems to propel the vehicle. All hybrid vehicles contain a traction battery to store electrical energy. In case of the regular hybrid vehicles, the battery is recharged only from the ICE system, while in case of the plug-in hybrids, the battery can also be recharged by plugging the battery charging electronics into the electric grid. In contrast with hybrid vehicles, battery electric vehicles (BEVs) do not have any ICE components, relying solely on one or more electric motors to propel the vehicle.

Vehicles in each of the aforesaid three broad categories utilize electric motors for vehicle propulsion. It should be noted that in case of BEVs, the one or more electric motors are the sole propulsion source for the BEV. To regulate the flow of electrical power from the vehicle battery into the electric motor(s), a special control system is used, which is conventionally named in the industry as “motor controller”. A combination of an electrical motor and a motor controller is commonly named in the industry as “drivetrain”.

As would be appreciated by persons of ordinary skill in the art, there are two broad types of electric drivetrains—a direct current (DC) drivetrain and an alternating current (AC) drivetrain. Both drivetrain technologies have certain advantages and certain trade-offs in practical applications. Specifically, the AC drivetrains are generally 15-25% more efficient than DC drivetrains due to the higher inherent efficiency of the AC motors and the ability to return some of the energy back into the batteries during breaking action. On the other hand, DC drivetrains generally have significantly higher power density—maximum mechanical power generated (conventionally measured in horsepower, 1 hp=0.736 kW), divided by the weight of the drivetrain. For example, the highest-power AC drivetrain available in passenger electric vehicles (Tesla Roadster) has a 189 kW peak power. At the same time, highest power DC drivetrain available in the same weight range is capable of delivering 400-500 kW peak power.

As a result of the aforesaid limitations of the conventional drivetrain designs, there are no commercially viable high-performance vehicle designs targeted at the mass market. High-performance offerings do exist but are limited to the high-end applications due to the cost and complexity of multiple AC motors/controllers required to achieve the target electric vehicle performance.

### SUMMARY OF THE INVENTION

The inventive methodology is directed to methods and systems that substantially obviate one or more of the above and other problems associated with conventional techniques for developing high-power (>200 kW peak power) electric drivetrains for passenger vehicles.

In accordance with one aspect of the invention, there is provided an electric vehicle drivetrain incorporating a hybrid motor assembly comprising an AC motor and a DC motor; a power stage configured to deliver a predetermined amounts of the electrical energy to the AC and DC motors, and a microprocessor-based control system configured to control the drivetrain.

In one or more embodiments, a driveshaft of the AC motor is mechanically coupled to a driveshaft of the DC motor.

In one or more embodiments, the AC motor and the DC motor share a common driveshaft.

In one or more embodiments, the hybrid motor assembly is mechanically coupled to one axle of the electric vehicle.

In one or more embodiments, the driveshaft of the AC motor is mechanically coupled to a first axle of the electric vehicle and the driveshaft of the DC motor is mechanically coupled to a second axle of the electric vehicle. In one or more embodiments, the first axle is a front axle and wherein the second axle is a rear axle of the electric vehicle.

In one or more embodiments, the microprocessor-based control system is configured to control the power stage to achieve a predetermined torque distribution between the first axle and the second axle.

In one or more embodiments, the microprocessor-based control system is configured to compute the predetermined torque distribution between the first axle and the second axle to manage dynamic stability of the electric vehicle.

In one or more embodiments, the microprocessor-based control system is configured to drive the power stage using a pulse-width-modulated (PWM) control signal.

In one or more embodiments, the microprocessor-based control system is configured to modify a duty cycle of the PWM control signal to adjust output currents of the AC motor and the DC motor according to a throttle pedal position of the electric vehicle.

In one or more embodiments, the power stage incorporates a DC power stage and an AC power stage.

In one or more embodiments, the DC power stage incorporates a “chopper” circuit and the AC power stage incorporates a three-phase inverter.

In one or more embodiments, the DC power stage and the AC power stage share a common cooling system.

In one or more embodiments, the microprocessor-based control system incorporates multiple sensors to monitor parameters necessary for the electric vehicle drivetrain control.

In one or more embodiments, the sensors include at least one of: battery/motor voltage, battery/motor current, battery/motor temperature, motor/wheel speed, motor/wheel spin coefficients sensors.

In one or more embodiments, the electric vehicle drivetrain further incorporates a temperature management system configured to control the operating parameters of the electric vehicle drivetrain system based on the instantaneous temperature of one or more of the components.

In one or more embodiments, the temperature management system is configured to derate the output of the power stage according to a predetermined temperature profile to protect the power components of the microprocessor-based control system and the AC and DC motors.

In one or more embodiments, the microprocessor-based control system incorporates an interface API and communication protocols for remote connection to an Integrated Vehicle Control System (IVCS).

In accordance with another aspect of the invention, there is provided an electric vehicle incorporating an electric vehicle drivetrain. The inventive electric vehicle drivetrain including: a hybrid motor assembly comprising an AC motor and a DC motor; a power stage configured to deliver a predetermined amounts of the electrical energy to the AC and DC motors, and a microprocessor-based control system configured to control the drivetrain.

In accordance with yet another aspect of the invention, there is provided a method for operating an electric vehicle drivetrain incorporating a hybrid motor assembly comprising an AC motor mechanically coupled to a first vehicle axle and a DC motor mechanically coupled to a second vehicle axle; a power stage configured to deliver a predetermined amounts of the electrical energy to the AC and DC motors, and a microprocessor-based control system configured to control the drivetrain. The inventive method involves: computing a torque distribution between the first axle and the second axle to manage dynamic stability of the electric vehicle; and controlling the power stage using a pulse-width-modulated (PWM) control signal to achieve the computed predetermined torque distribution between the first axle and the second axle.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates an exemplary embodiment of an inventive hybrid drivetrain for an electric vehicle in a single axle drive configuration.

FIG. 2 illustrates an exemplary embodiment of an inventive hybrid drivetrain for an electric vehicle in an all-wheel drive configuration.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

In accordance with one aspect of the present invention, there is provided a hybrid AC/DC drivetrain hardware architecture providing necessary control functions and mechanical connections—allowing for up to 600 kW total power output power at much lower cost and complexity than any existing solutions.

Various embodiments include a three-part architecture consisting of (1) the hybrid motor assembly incorporating both AC and DC motor architectures to combine high power of the DC motor with the efficiency of the AC motor, (2) the power stage that delivers the precise amount of the electrical energy to the motors, and (3) the microprocessor-based control system that performs all the control functions of the drivetrain.

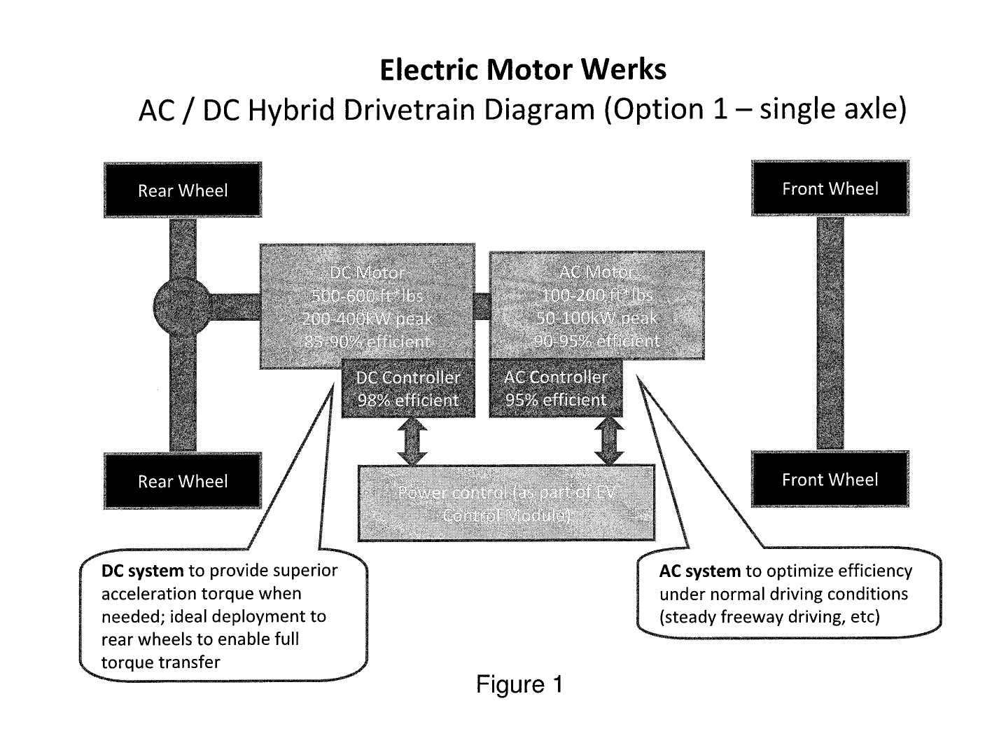

Various embodiments include a hybrid AC/DC motor assembly that features one DC motor and one AC motor arranged back to back with their two driveshafts mechanically coupled, or by using single common driveshaft, as shown in FIG. 1. In this arrangement, the motors can be integrated into one unit by removing back/front plates and replacing individual shafts with a single shaft. Mechanical connection of such a motor assembly to the wheels can be performed via the conventional transmission/driveshaft, such that the mechanical power is applied by the described hybrid AC/DC motor assembly to only one electric vehicle axle, as shown in FIG. 1.

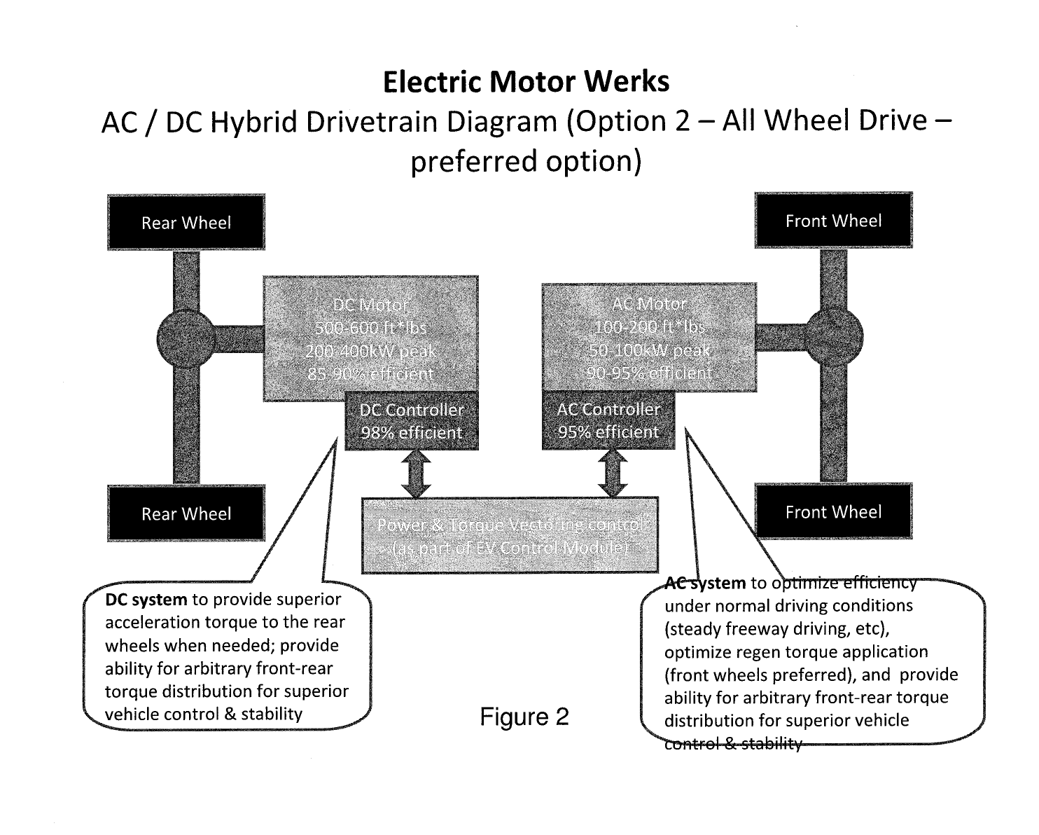

Various embodiments include a hybrid AC/DC assembly that features one AC motor powering one set of vehicle's wheels (e.g., front axle/wheels) and one DC motor powering another set of vehicle's wheels (e.g., rear axle/wheels), as illustrated in FIG. 2. This configuration is particularly beneficial for the end-user applications as it uses the AC and DC motor technologies to its fullest potential. Specifically, it is well known that 70% of the braking power is originating from the front axle (as the vehicle's mass distribution shifts to the front during the braking event). At the same time, the rear axle provides optimal application point of the acceleration power, with up to 2:1 ratio of maximum possible acceleration between rear and front axles. Connecting a regenerating AC motor to the front axle and power-boosting DC motor to the rear axle maximizes utilization of these characteristics. Furthermore, it allows application of a sophisticated level of torque control between the two axles, dramatically improving the dynamic stability of the vehicle. Lastly, such an arrangement increases overall drivetrain efficiency as the smaller (e.g., 100 kW), more efficient AC motor can be used in all steady-state driving up to 90-100 mph, while the larger DC motor can be used during acceleration events and at speeds above 100 mph.

Various embodiments include a power stage to deliver any pre-set level of power to the motor assembly system—limited only to the total power available from the primary power source (battery) of the electric vehicle. In one embodiment, the power stage is driven by the pulse-width-modulated (PWM) signal from the microprocessor control system of the electric vehicle.

Various embodiments include a power stage consisting of two parts: (1) a DC power stage, and (2) an AC power stage. Both stages can be realized using the existing power semiconductor components and a set of passive discreet components (capacitors, resistors, etc.). The conventional designs of the power stages can be adopted for this application—a “chopper” circuit for the DC stage, and a three-phase inverter for the AC stage. Control of both power stages is performed using the pulse-width-modulated signals—one phase for the DC stage, three phases for the AC stage. The AC motor and power stage can be either an induction or permanent magnet-based.

The integration of the DC and AC control and power stages in one system allows substantial cost savings, space savings, increased reliability of the drivetrain through redundancy, ability to maximize efficiency depending on operating parameters, and ability to perform graceful failover. Specifically, it allows: (1) use of the same cooling system for both power stages, (2) use of the same control microprocessor for both control stages, (3) load/torque balancing between the two propulsion systems/two electric vehicle axles. The ability to manage dynamic stability through separate management of front and rear axles is especially beneficial in the high-performance applications.

Various embodiments include a control system that accepts the input from various vehicle sensors and provides the PWM control signals for the power stages. Such a control system is based on the advanced microprocessor technology and generally consists of 4 major parts: (a) DC chopper control circuitry & software algorithms, (b) AC inverter control circuitry & software algorithms using the VFD (Variable Frequency Drive) technology, (c) an intelligent power management circuitry & software algorithms (herein referred to as IPM) to adjust the relative power and functions of the AC and DC drivetrain systems, and (d) sensor circuitry incorporating inputs from various vehicle subsystems.

Various embodiments include IGBT driver circuits optimized to deliver the optimal levels of driving currents and transition timing. The PCB boards containing such circuits are to be placed directly on the IGBT switch devices to minimize stray inductances in the circuit—critical to ensure the reliable operation of the circuit at the required power levels.

Various embodiments include a microprocessor-based control system capable of controlling an arbitrary number of the power stages, AC or DC, and integrate among them in a way maximizing the total power output and dynamic stability of the vehicle. A control system modifies a PWM duty cycle to adjust the output motor current according to the throttle pedal position (and, therefore, the desired acceleration level). Such control is realized via a PID control loop (Proportional-Integral-Differential loop), with loop parameters tuned specifically for the range of operating conditions of the control system. This approach allows to optimize the response speed and power output of the drivetrain and results in maximum level of overall vehicle responsiveness and driveability.

Various embodiments include a microprocessor-based control system incorporating a universal set of sensors to monitor all possible parameters necessary for drivetrain control—including but not limited to battery/motor voltage, battery/motor current, battery/motor temperature, motor/wheel speed, motor/wheel spin coefficients (to detect slippage in a clutch system or between wheels and a surface).

Various embodiments include a hardware-based maximum output current control that filters the output switching signal from the microprocessor according to the instantaneous output current. This system receives the signal from the microprocessor that defines the output current threshold, thus making the current control system fully programmable through the microcontroller system.

Various embodiments include a temperature management system that controls the operating parameters of the overall drivetrain system based on the instantaneous temperature of one or more of the components. Such a system derates the power stage output according to the pre-set temperature profile to protect the power components of the control system and the motors. The derating can be applied to AC and DC portion of the drivetrain separately or together.

Various embodiments include an interface system connected to the micro-processor control board. Such an interface system is used to set the appropriate driving profiles and advanced parameters. Such an interface system consists of an LCD screen and a small keyboard to accept user inputs.

Various embodiments include an interface API and communication protocols for remote connection to the Integrated Vehicle Control System (IVCS). Such IVCS can be designed to manage communications and mutual operations of all EV components. Through system-level integration, many additional functionalities can be made possible, including but not limited to, coulomb metering for accurate fuel gauge readout, integration of the EV components with all original vehicle's components through CANbus, etc. Additionally, such system can be set up to connect to external consumer electronics devices (phones, PCs, etc.) equipped with appropriate user interface software.

Moreover, other implementations of the invention will be apparent to those skilled in the art from consideration of the specification and practice of the invention disclosed herein. Various aspects and/or components of the described embodiments may be used singly or in any combination in the electric drivetrains for passenger vehicles. It is intended that the specification and examples be considered as exemplary only, with a true scope and spirit of the invention being indicated by the following claims.

What is claimed is:

1. An electric vehicle drivetrain comprising:
a. a hybrid motor assembly comprising an AC motor and a DC motor;
b. a power stage configured to deliver a predetermined amounts of the electrical energy to the AC and DC motors, and
c. a microprocessor-based control system configured to control the drivetrain.

2. An electric vehicle drivetrain of claim 1, wherein a driveshaft of the AC motor is mechanically coupled to a driveshaft of the DC motor.

3. An electric vehicle drivetrain of claim 1, wherein the AC motor and the DC motor share a common driveshaft.

4. An electric vehicle drivetrain of claim 1, wherein the hybrid motor assembly is mechanically coupled to one axle of the electric vehicle.

5. An electric vehicle drivetrain of claim 1, wherein the driveshaft of the AC motor is mechanically coupled to a first axle of the electric vehicle and the driveshaft of the DC motor is mechanically coupled to a second axle of the electric vehicle.

6. The electric vehicle drivetrain of claim 5, wherein the first axle is a front axle and wherein the second axle is a rear axle of the electric vehicle.

7. The electric vehicle drivetrain of claim 5, wherein the microprocessor-based control system is configured to control the power stage to achieve a predetermined torque distribution between the first axle and the second axle.

8. The electric vehicle drivetrain of claim 7, wherein the microprocessor-based control system is configured to compute the predetermined torque distribution between the first axle and the second axle to manage dynamic stability of the electric vehicle.

9. The electric vehicle drivetrain of claim 1, wherein the microprocessor-based control system is configured to drive the power stage using a pulse-width-modulated (PWM) control signal.

10. The electric vehicle drivetrain of claim 1, wherein the microprocessor-based control system is configured to modify a duty cycle of the PWM control signal to adjust output currents of the AC motor and the DC motor according to a throttle pedal position of the electric vehicle.

11. The electric vehicle drivetrain of claim 1, wherein the power stage comprises a DC power stage and an AC power stage.

12. The electric vehicle drivetrain of claim 11, wherein the DC power stage comprises a “chopper” circuit and the AC power stage comprises a three-phase inverter.

13. An electric vehicle drivetrain of claim 11, wherein the DC power stage and the AC power stage share a common cooling system.

14. The electric vehicle drivetrain of claim 1, wherein the microprocessor-based control system comprises a plurality sensors to monitor parameters necessary for the electric vehicle drivetrain control.

15. The electric vehicle drivetrain of claim 14, wherein the plurality of sensors comprise at least two of: battery/motor voltage sensors, battery/motor current sensors, battery/motor temperature sensors, motor/wheel speed sensors, and motor/wheel spin coefficients sensors.

16. The electric vehicle drivetrain of claim 1, further comprising a temperature management system configured to control the operating parameters of the electric vehicle drivetrain system based on the instantaneous temperature of one or more of the components.

17. The electric vehicle drivetrain of claim 16, wherein the temperature management system is configured to derate the output of the power stage according to a predetermined temperature profile to protect the power components of the microprocessor-based control system and the AC and DC motors.

18. The electric vehicle drivetrain of claim 1, wherein the microprocessor-based control system comprises an interface API and communication protocols for remote connection to an Integrated Vehicle Control System (IVCS).

19. An electric vehicle comprising an electric vehicle drivetrain, the electric vehicle drivetrain comprising:
a. a hybrid motor assembly comprising an AC motor and a DC motor;
b. a power stage configured to deliver a predetermined amounts of the electrical energy to the AC and DC motors, and
c. a microprocessor-based control system configured to control the drivetrain.

20. A method for operating an electric vehicle drivetrain comprising: a hybrid motor assembly comprising an AC motor mechanically coupled to a first vehicle axle and a DC motor mechanically coupled to a second vehicle axle; a power stage configured to deliver a predetermined amounts of the electrical energy to the AC and DC motors, and a microprocessor-based control system configured to control the drivetrain, the method comprising:
a. computing a torque distribution between the first axle and the second axle to manage dynamic stability of the electric vehicle; and
b. controlling the power stage using a pulse-width-modulated (PWM) control signal to achieve the computed predetermined torque distribution between the first axle and the second axle.
